(19) United States
(12) Patent Application Publication
(10) Pub. No.: US 2006/0288951 A1
(43) Pub. Date: Dec. 28, 2006

(54) A glass fish bowl which becomes curved surface

(76) Inventor: Mu Yeong LEE, Gyeongsangnam-Do (KR)

Correspondence Address: IPLA P.A., 3580 WILSHIRE BLVD., 17TH FLOOR, LOS ANGELES, CA, 90010, US

(21) Appl. No.: 10/595,408

(22) PCT Filed: Jul. 9, 2004
(86) PCT No.: PCT/KR04/01720

§ 371 Date: Apr. 14, 2006

(30) Foreign Application Priority Data
Oct. 16, 2003 (KR) 20-2003-0032479
Oct. 16, 2003 (KR) 20-2003-0032481
Oct. 16, 2003 (KR) 20-2003-0032480

(51) Int. Cl. A01K 63/00

(52) U.S. Cl. 119/245

(57) ABSTRACT

The present invention relates to a table with a transparent aquarium, wherein the aquarium is constructed by engaging each component panel with connecting members without an outer frame or other supporting members; the material of the aquarium is transparent; the shape of aquarium is curved; a plurality of aquariums are connected with a connecting channel made of plural panels so as to save the time and the cost for manufacturing and achieve nice figure.

### TECHNICAL FIELD

The present invention relates to a fish bowl with a curved surface, and more particularly, to a fish bowl with a curved surface that is provided with a water tank that is formed of a transparent panel that is curved, without having any support member like an outer frame, and also with a plurality of water tanks that communicate with one another by means of a passage panel, such that the time and expense needed for manufacturing the fish bowl can be substantially reduced and a lighting lamp is positioned inside the bowl, and hence the outer appearance can be more beautiful.

### BACKGROUND ART

Generally, the fish bowls, which are used for keeping small or tropical fish therein, includes a plurality of glass panels on outer walls thereof and outer frames for supporting and connecting the plurality of glass panels. In accordance with the types of the support outer frames, the fish bowls are used for a variety of purposes, for example, hangers on walls, cabinets, ornaments, and the like.

FIG. 1 is a perspective view of a conventional fish bowl.

As shown in FIG. 1, the conventional fish bowl includes a plurality of support legs 6, an outer frame 1 provided around an outer peripheral surface thereof and having a plurality of bars 5 for fixing the support legs 6, a bottom panel 2 provided at the bottom thereof, a water tank 3 supportably mounted on the bottom plate 2 and disposed inside the outer frame 1, and a top plate 4 placed on the top of the water tank 3 to be used as the top surface of a kind of table.

For the conventional fish bowl, however, a plurality of glass panels which constitute the water tank 3, the top plate 4, and the bottom plate 3 are generally bonded to one other by use of an adhesive, for the installation inside the outer frame 1. This needs a lot of materials and a number of complicated manufacturing processes, which makes it difficult to reduce the time and expense required for manufacturing the fish bowl.

In addition, the conventional fish bowl places the water tank 3 inside the outer frame 1, and when a lighting lamp is installed inside the water tank 3, the shadow of the outer frame 1 is made by the light emitted to the outside from the lamp, which ruins the outer appearance.

### DISCLOSURE OF INVENTION

Accordingly, the present inventor has been made to solve the above-described problems, and it is an object of the present invention to provide a fish bowl with a curved surface that is provided with a water tank that is made of a transparent cylindrical panel, without having any additional outer frame or support member around an outer periphery thereof, such that the time and expense used for manufacturing the fish bowl can be substantially reduced, and when a lighting lamp is positioned inside the bowl, the shadow of the outer frame is not made in the fish bowl, thereby making the outer appearance more beautiful.

Another object of the present invention is to provide a fish bowl with a curved surface that is provided with a plurality of water tanks that communicate with one another by means of respective passage panels, each of the water tanks being formed of a single panel made of a transparent material, such that the whole outer appearance can be made in various shapes.

To accomplish the above objects, according to a first embodiment of the present invention, there is provided a fish bowl with a curved surface that includes: a generally cylindrical water tank made of a transparent material and formed by bonding a single panel at both side end portions thereof for forming a predetermined space portion therein; a bottom panel bonded to a peripheral bottom end of the water tank for preventing water in the water tank from leaking outside; a sealing material applied to the connected portion between the both side end portions of the panel of the water tank and to the connected portion between the peripheral bottom end of the water tank and the edge portion of the bottom panel, for preventing leakage of water in the water tank; and a top plate mounted on a peripheral top end of the water tank, for forming the top surface of a kind of table, the top plate having a plurality of seating protrusions protruded downwardly from the underneath surface thereof for allowing the outer peripheral surface of a top end portion of the water tank being in tight contact with the inner surfaces of the seating protrusions upon the coupling of the top plate to the water tank.

To accomplish the above objects, according to a second embodiment of the present invention, there is also provided a fish bowl with a curved surface that includes: a plurality of water tanks each having a generally cylindrical panel made of a transparent material and bent for defining a predetermined space portion therein, each water tank having a hole portion formed along a vertical direction between both side end portions thereof; a plurality of passage panels for connecting the both side end portions of each of the plurality of water tanks to each other to form passages between the adjacent water tanks, such that the plurality of water tanks communicate with one another; a bottom panel bonded to the peripheral bottom ends of the water tanks and the passage panels for water in the water tanks and passages formed by the passage panels from leaking outside; a sealing material applied to a connected portion between each of the water tanks and each of the passage panels, and to a connected portion between each of the peripheral bottom ends of the water tanks and passage panels and the bottom panel, for preventing water in the water tank from leaking outside; and a top plate mounted on the peripheral top ends of the water tanks and passage panels, for forming the top surface of a kind of table, the top plate having a plurality of seating protrusions protruded downwardly from the underneath surface thereof for allowing the outer peripheral surface of a top end portion of the water tank to be in tight contact with the inner surface of the seating protrusions upon the coupling of the top plate to the water tank.

Preferably, each of the passage panels is connected to the hole portion of one of the water tanks at one side end portion thereof and connected to the passage panel extended from another water tank at the other side end portion thereof such that at least two water tanks communicate with each other.

To accomplish the above object, according to a third embodiment of the present invention, there is provided a fish bowl with a curved surface that includes: a water tank made of a transparent material and having an outwardly concave curve or an inwardly convex curve, the water tank having a pair of first panels provided to form the front and back surfaces thereof and a pair of second panels connected at opposed both side end portions of each of the pair of first panels, for defining a predetermined space portion within the first and second panels; a bottom panel bonded to a peripheral bottom end of the water tank for water in the water tank from leaking outside; a sealing material applied to the connected portions between the first panels and the second panels and to the connected portion between the peripheral bottom end of the water tank and the edge portion of the bottom panel, for preventing water in the water tank from leaking outside; and a cover detachably mounted on the top of the water tank and having an upwardly concave curved surface or a downwardly convex curved surface, the cover being made of a transparent material.

Preferably, the cover has a lighting lamp provided inside thereof and a reflection plate positioned just over lighting lamp for preventing the light emitted from the lighting lamp from being transmitted to the outside.

### BRIEF DESCRIPTION OF THE DRAWINGS

Further objects and advantages of the invention can be more fully understood from the following detailed description taken in conjunction with the accompanying drawings, in which:

FIG. 1 is a perspective view of a conventional fish bowl;

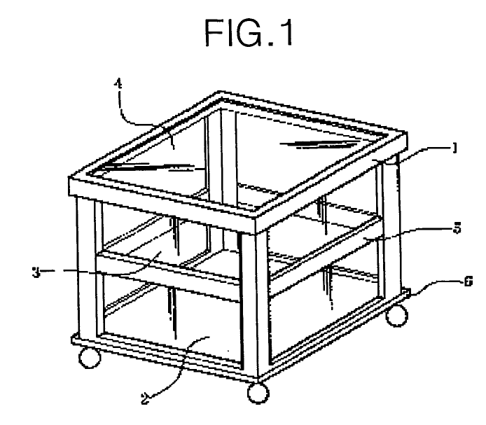

FIG. 2 is a perspective view of a fish bowl with a curved surface according to a first embodiment of the present invention;

FIG. 3 is an exploded perspective view of FIG. 2;

FIG. 4 is a view of describing a usage example of the fish bowl of FIG. 2;

FIG. 5 is a view of describing another usage example of the fish bowl of FIG. 2;

FIG. 6 is a perspective view of a fish bowl with a curved surface according to a second embodiment of the present invention;

FIG. 7 is an exploded perspective view of FIG. 6;

FIG. 8 is a plan view of a fish bowl with a curved surface according to a third embodiment of the present invention;

FIG. 9 is a plan view of a fish bowl with a curved surface according to a fourth embodiment of the present invention;

FIG. 10 is a view of describing a usage example of the fish bowl of FIG. 6;

FIG. 11 is a perspective view of a fish bowl with a curved surface according to a fifth embodiment of the present invention;

FIG. 12 is an exploded perspective view of FIG. 11;

FIG. 13 is a sectional view of FIG. 11; and

FIG. 14 is a view of describing a usage example of the fish bowl of FIG. 11.

### BEST MODE FOR CARRYING OUT THE INVENTION

Now, an explanation on the preferred embodiments of the present invention will be in detail given with reference to attached drawings.

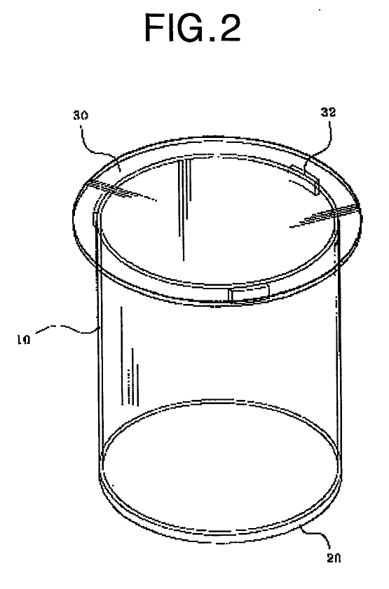

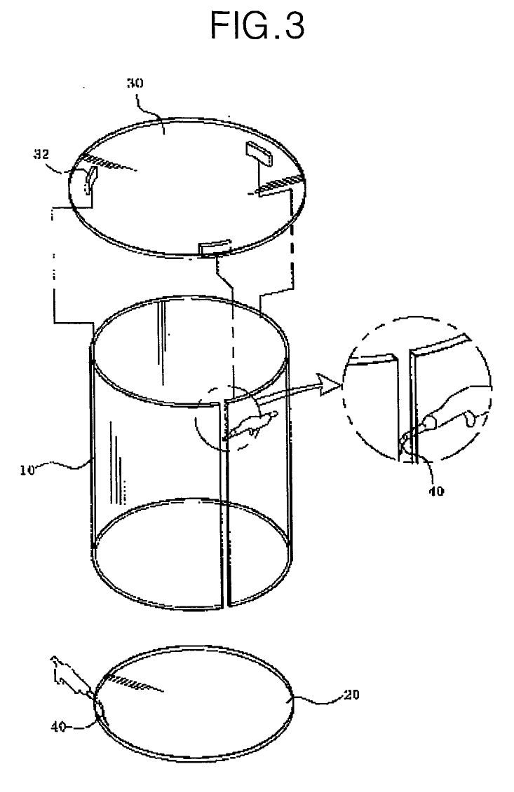

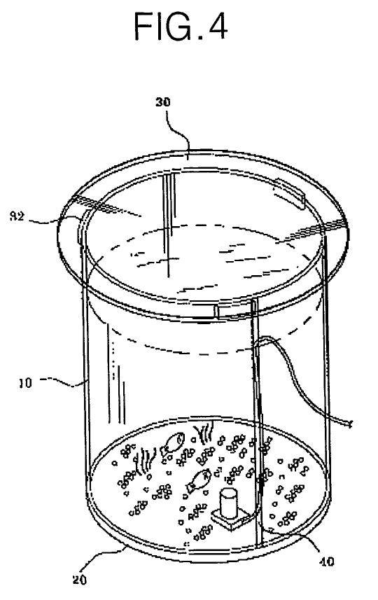

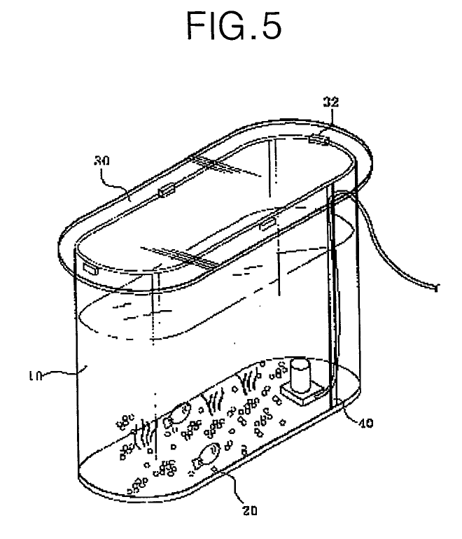

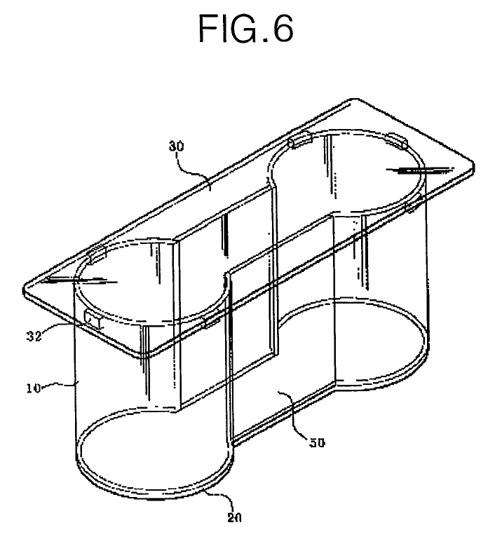

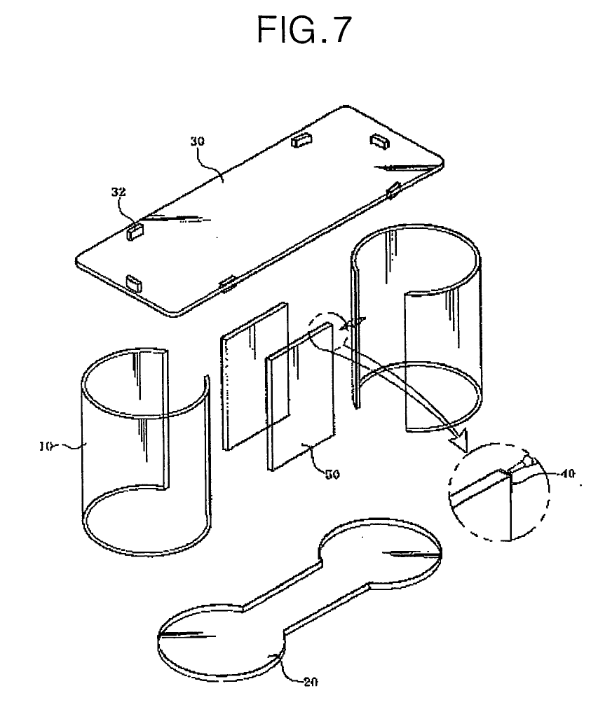

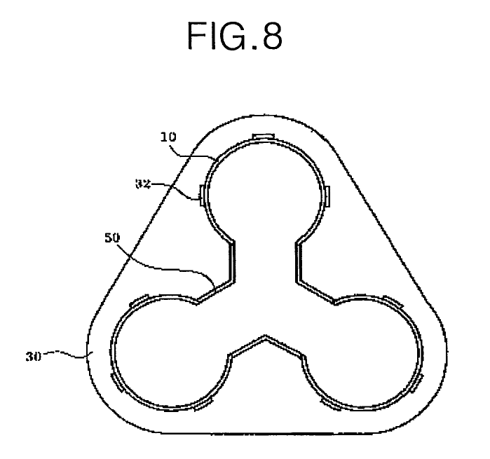

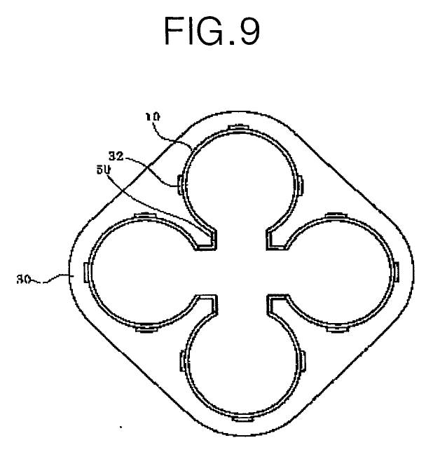

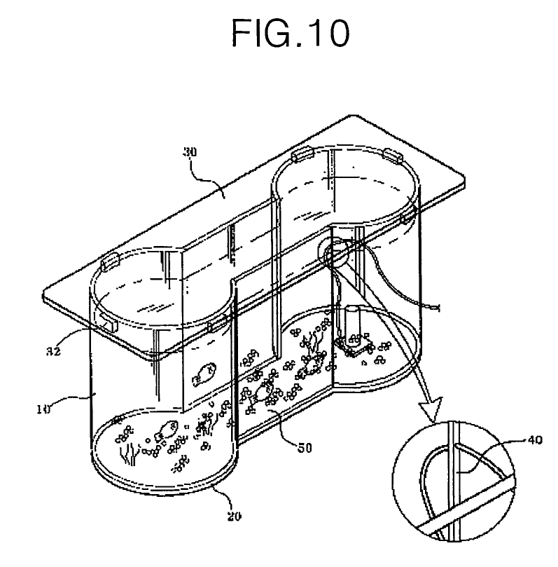

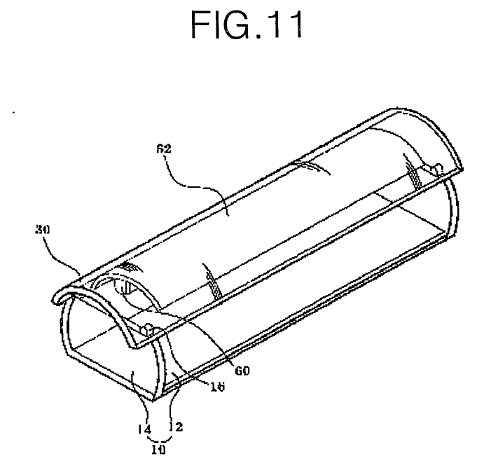

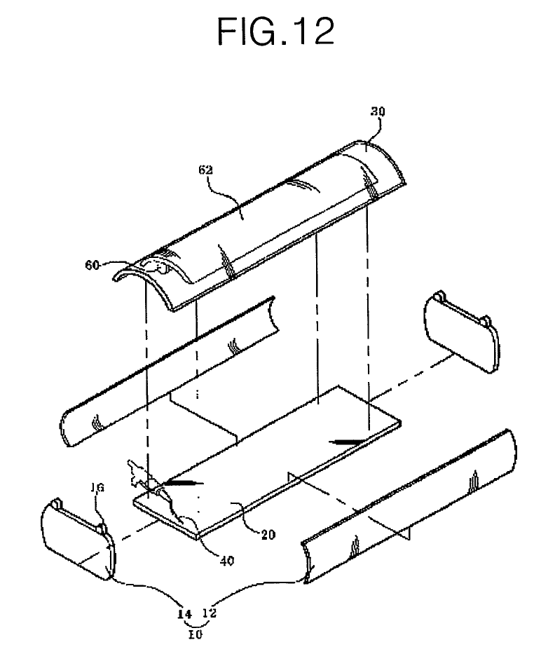

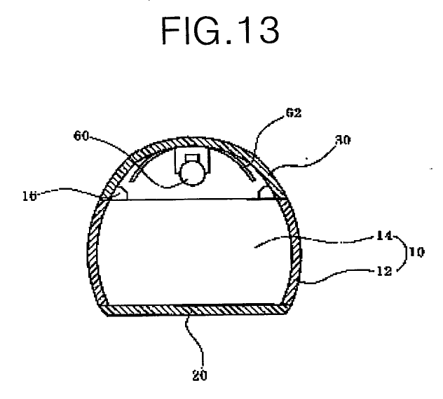

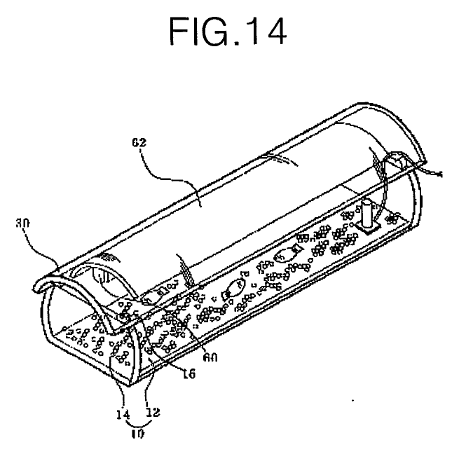

FIG. 2 is a perspective view of a fish bowl with a curved surface according to a first embodiment of the present invention, FIG. 3 is an exploded perspective view of FIG. 2, FIG. 4 is a view of describing a usage example of the fish bowl of FIG. 2, FIG. 5 is a view of describing another usage example of the fish bowl of FIG. 2, FIG. 6 is a perspective view of a fish bowl with a curved surface according to a second embodiment of the present invention, FIG. 7 is an exploded perspective view of FIG. 6, FIG. 8 is a plan view of a fish bowl with a curved surface according to a third embodiment of the present invention, FIG. 9 is a plan view of a fish bowl with a curved surface according to a fourth embodiment of the present invention, FIG. 10 is a view of describing a usage example of the fish bowl of FIG. 6, FIG. 11 is a perspective view of a fish bowl with a curved surface according to a fifth embodiment of the present invention, FIG. 12 is an exploded perspective view of FIG. 11, FIG. 13 is a sectional view of FIG. 11, and FIG. 14 is a view of describing a usage example of the fish bowl of FIG. 11.

Referring to FIGS. 2 to 4, according to a first embodiment of the present invention, there is shown a fish bowl with a curved surface that includes: a substantially cylindrical water tank 10 formed by bonding a single panel at both side end portions thereof for defining a predetermined space portion therein; a bottom panel 20 bonded to a peripheral bottom end of the water tank 10 for preventing water the water tank 10 from leaking outside; and a top plate 40 mounted on a peripheral top end of the water tank 10, for forming the top surface of a kind of table.

In this case, the cylindrical water tank 10 is formed of a cylindrical panel that is made of a transparent glass material, such that the interior of the bowl can be clearly seen. The fish bowl of the present invention does not have any outer frame as compared with the conventional bowls, and moreover, the single glass panel is bent to form the cylindrical water tank 10, such that the connected portion of the panel at the both side end portions thereof is linearly formed along a vertical direction of the water tank 10, which permits the interior of the water tank 10 to be observed without any refraction of light.

Of course, a glass panel having excellent transparency is most preferably employed as the transparent panel. A transparent synthetic resin may be also used as the transparent panel.

In the case where the water tank 10 is formed of the glass panel, it is not easy to bent the glass panel to a substantial cylindrical shape, and therefore, the glass panel is placed along the outer peripheral surface of a cylindrical container like a drum and is subjected to the heat treatment at 600° C. to 700° C., thereby making the cylindrical water tank 10.

At this time, as the drum is rotated at a predetermined speed, the glass panel is wound along the outer peripheral surface of the drum, thereby finishing the molding.

Moreover, the bottom panel 20 is bonded to a peripheral bottom end of the water tank 10 to which a sealing material 40 is spread and then dried, which prevents the water in the water tank 10 from leaking outside.

As shown in FIGS. 2 and 3, the top plate 30 has a substantially larger diameter than the water tank 10, and when it is mounted on a peripheral top end of the water plate 10, thus, the top surface of the top plate is formed large to thereby form a kind of table. The top plate 30 has various shapes such as rectangular, triangular, round, or the like. The top plate 30 is provided with a plurality of seating protrusions 32 that are protruded downwardly from the underneath surface thereof.

The seating protrusions 42 of the top plate 30 are at the inner surfaces thereof in a tight contact with the outer peripheral surface of the water tank 10 when the top plate 30 is mounted on the peripheral top end of the water tank 10, such that the top plate 30 is not moved out of the peripheral top end of the water tank 10 even by the application of external forces.

In this case, each of the seating protrusions 42 has the same curvature as the water tank 10 and is bonded at the top surfaces thereof to the underneath surface of the top plate 30 by means of the sealing material 40. The number of seating protrusions 42 may be determined enough to suppress the movement of the top plate 30, and in that case, they may take all types of shapes.

Now, an explanation on a method for manufacturing the fish bowl with the curved surface according to the first embodiment of the present invention will be given.

First, a predetermined size of glass panel is placed along the outer peripheral surface of the drum and is subjected to the heat treatment at 600° C. to 700° C., while rotating the drum, thereby making a cylindrical water tank 10 that has the corresponding end portions at both sides of the glass panel.

Next, a sealing material 40 is applied to the connected portion between the both side end portions of the glass panel, as shown in FIG. 3, and then, the connected portion is in a tight contact state and dried, thereby forming the cylindrical water tank 10.

Then, the sealing material 40 is applied to the peripheral bottom end of the water tank 10, and the bottom panel 20 that has a similar diameter to the water tank 10 is bonded to the portion on which the sealing material 40 is applied, thereby preventing water in the water tank 10 from leaking outside.

Finally, the top plate 30 having the plurality of seating protrusions 32 is mounted on the peripheral top end of the water tank 10, thereby producing the fish bowl according to the present invention.

The fish bowl with the curved surface is finished in such a manner that sand and other things are spread inside the bottom panel 20 and a hole portion is formed at the top side of the connected portion formed by the sealing material 40, through which an oxygen generator is placed inside the water tank 10.

FIG. 5 is a view of showing another usage example of the fish bowl of FIG. 2.

In the same manner as FIG. 2, the fish bowl has a water tank 10, a bottom panel 20, a top plate 30, and a sealing material 40, but in this case, the water tank 10 has a different shape, that is, an oval shape. In correspondence therewith, accordingly, the fish bowl is characterized in that the bottom panel 20 and the top plate 30 are in the shape of an oval.

On the other hand, according to a second embodiment of the present invention, the fish bowl with the curved surface further includes a plurality of passage panels 50 each connecting the water tanks 10 to each other such that the water tanks 10 communicate with one another.

Referring to FIGS. 6 and 7, each of the passage panel 50 has the same height as the water tank 10 and is formed of glass. The passage panels 50 are bonded to the hole portions formed vertically along the peripheries of the water tanks 10 at the both side end portions thereof, thereby providing passages between the adjacent water tanks 10.

Of course, the passage panel 50 is also made of a transparent glass, but may be also made of a transparent synthetic resin.

Moreover, the bonding between the water tank 10 and the passage panel 50 is achieved by means of the sealing material 40 containing silicon, etc., as shown in FIG. 7, which is desirably white such that it matches the transparent water tank 10 and the passage panel 50.

FIG. 8 is a plan view of a fish bowl with a curved surface according to a third embodiment of the present invention.

In the same manner as the second embodiment of the present invention, the third embodiment of the present invention has water tanks 10, bottom panels 20, top plates 30, passage panels 50, and seating protrusions 32, but in this case, the water tanks 10 and the passage panels 50 are different in number. As shown in FIG. 8, the number of water tanks 10 is three, and each of the passage panels 50 is connected to the hole portion of one of the water tanks 10 at one side end portion thereof and is connected to the passage panel 52 extended from another water tank 10 at the other side end portion thereof, such that the respective water tanks 10 are oriented at an angle of 120°.

FIG. 9 is a plan view of a fish bowl with a curved surface according to a fourth embodiment of the present invention.

In the same manner as the third embodiment of the present invention, the fourth embodiment of the present invention also has water tanks 10 and passage panels 50 that are different in number. As shown in FIG. 9, the number of water tanks 10 is four, and each of the passage panels 50 is connected to the hole portion of one of the water tanks 10 at one side end portion thereof and is connected to the passage panel 54 extended from another water tank 10 at the other side end portion thereof, such that the respective water tanks 10 are oriented at an angle of 90°.

Thereby, the top plate 30 has a generally triangular shape in the third embodiment of the present invention and has a generally regular square shape in the fourth embodiment of the present invention.

Of course, the number of water tanks 10 and passage panels 50 are freely determined in accordance with the arrangement thereof, and if the fish bowl is used for homes, desirably, the number of water tanks 10 is three or four.

Referring to FIGS. 10 to 14, according to a fifth embodiment of the present invention, a fish bowl with a curved surface includes: a water tank 10 made of a transparent material for forming a predetermined space portion and having an outwardly concave curved surface formed at sides thereof; a bottom panel 20 bonded to a peripheral bottom end of the water tank 10 for preventing water in the water tank 10 from leaking outside; a sealing material 40 applied for connecting a plurality of panels constituting the water tank 10 to one another and for connecting the water tank 10 and the bottom panel 20, such that leakage of water in the water tank 10 is prevented; and a top plate 50 detachably mounted on the top surface of the water tank 10.

In this case, the water tank 10 is provided with a pair of first panels 12 that take a shape of a substantially long rectangle along left and right directions to form the front and back faces thereof and with a pair of second panels 14 that are connected at opposed both sides of the first panels 12 to thereby define a predetermined space portion within the first and second panels. Then, the sealing material 40 containing silicon, etc., is spread on the end portions of the first panels 12 and the second panels 14 and is thus dried, thereby finishing the bonding between the first and second panels.

Each of the first panels 12 has an outwardly concave curved surface and thus makes the outer appearance of the bowl look wonderful as compared with that having a flat type of panel. In order to form the first panels 12 of the concave curved shape, a glass panel is placed along the outer periphery of a drum having a predetermined curvature and is then subjected to the heat treatment at 600° C. to 700° C., such that the glass panel comes into close contact with the outer periphery of the drum thus to have the same curvature as the drum. Thus, the curved glass panel is finally made.

Each of the second panels 14 is curved at opposed both side end portions thereof, as shown in FIGS. 11 and 12, in such a manner as to correspond with the first panels 12, and is flat at top and bottom ends in order to position the water tank 10 stably at a flat place. Each second panel 14 is provided with a pair of protrusions 16 that are formed at both sides of the top end thereof for keeping the top plate 30 from being moved after placed on the peripheral top end of the water tank 10.

The top plate 30 that is employed in the fifth embodiment of the present invention has a substantially long rectangular shape along left and right directions, as shown in FIG. 11, and it has an upwardly concave curved surface and a lighting lamp 60 for emitting light towards the water tank 10 at the inner wall thereof.

In the same manufacturing method as the first panels 12, the top plate 30 is made by placing a glass panel along the outer periphery of a drum having a predetermined curvature and by applying heat at 600° C. to 700° C. Thus, the curved glass panel is finally made.

Between the lighting lamp 60 and the top plate 30 is provided a reflection plate 62 that is made of a material capable of preventing light from being transmitted, such that the lighting lamp 60 that is placed inside the top plate 30 can emit the light only toward the interior of the water tank 10. The reflection plate 62 is formed of a white synthetic resin panel or mirror, which makes the outer appearance of the fish bowl more beautiful when the lighting lamp 60 emits the light.

Moreover, the first panels 12 and the top plate 30 may have inwardly convex curves in accordance with a user's preference, and their curvature may be varied depending upon user's selection.

### INDUSTRIAL APPLICABILITY

As set forth in the foregoing, a fish bowl with a curved surface according to the present invention is made in such a manner that a single glass panel is bent to form a substantially cylindrical water tank, a bottom panel is bonded to the water tank, and a top plate that has a substantially larger diameter than the water tank is mounted on a peripheral top end of the water tank, such that the time and expense needed for manufacturing the fish bowl can be substantially reduced. Also, the fish bowl is provided with a lighting lamp that is placed in the interior of the bowl, thereby making the outer appearance more beautiful.

Additionally, the fish bowl of the present invention is made in such a manner that a plurality of water tanks communicate with one another by means of a plurality of passage panels, a bottom panel is bonded to the water tanks and the passage panels, and a top plate is mounted on a peripheral top end of the water tanks, such that a variety of fish bowls can be provided in accordance with the number of the water tanks.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A fish bowl with a curved surface, comprising:
a generally cylindrical water tank made of a transparent material and formed by bonding a single panel at both side end portions thereof for forming a predetermined space portion therein;
a bottom panel bonded to a peripheral bottom end of the water tank for preventing water in the water tank from leaking outside;
a sealing material applied to the connected portion between the both side end portions of the panel of the water tank and to the connected portion between the peripheral bottom end of the water tank and the edge portion of the bottom panel, for preventing leakage of water in the water tank; and
a top plate mounted on a peripheral top end of the water tank, for forming the top surface of a kind of table, the top plate having a plurality of seating protrusions protruded downwardly from the underneath surface thereof for allowing the outer peripheral surface of a top end portion of the water tank being in tight contact with the inner surfaces of the seating protrusions upon the coupling of the top plate to the water tank.

2. A fish bowl with a curved surface, comprising:
a plurality of water tanks each having a generally cylindrical panel made of a transparent material and bent for defining a predetermined space portion therein, each water tank having a hole portion formed along a vertical direction between both side end portions thereof;
a plurality of passage panels for connecting the both side end portions of each of the plurality of water tanks to each other to form passages between the adjacent water tanks, such that the plurality of water tanks communicate with one another;
a bottom panel bonded to the peripheral bottom ends of the water tanks and the passage panels for water in the water tanks and passages formed by the passage panels from leaking outside;
a sealing material applied to a connected portion between each of the water tanks and each of the passage panels, and to a connected portion between each of the peripheral bottom ends of the water tanks and passage panels and the bottom panel, for preventing water in the water tank from leaking outside; and
a top plate mounted on the peripheral top ends of the water tanks and passage panels, for forming the top surface of a kind of table, the top plate having a plurality of seating protrusions protruded downwardly from the underneath surface thereof for allowing the outer peripheral surface of a top end portion of the water tank to be in tight contact with the inner surface of the seating protrusions upon the coupling of the top plate to the water tank.

3. A fish bowl according to claim 2, wherein each of the passage panels is connected to the hole portion of one of the water tanks at one side end portion thereof and connected to the passage panel extended from another water tank at the other side end portion thereof such that at least two water tanks communicate with each other.

4. A fish bowl with a curved surface, comprising:
a water tank made of a transparent material and having an outwardly concave curve or an inwardly convex curve, the water tank having a pair of first panels provided to form the front and back surfaces thereof and a pair of second panels connected at opposed both side end portions of each of the pair of first panels, for defining a predetermined space portion within the first and second panels;
a bottom panel bonded to a peripheral bottom end of the water tank for water in the water tank from leaking outside;
a sealing material applied to the connected portions between the first panels and the second panels and to the connected portion between the peripheral bottom end of the water tank and the edge portion of the bottom panel, for preventing water in the water tank from leaking outside; and
a cover detachably mounted on the top of the water tank and having an upwardly concave curved surface or a downwardly convex curved surface, the cover being made of a transparent material.

5. A fish bowl according to claim 4, wherein the cover has a lighting lamp provided inside thereof and a reflection plate positioned just over lighting lamp for preventing the light emitted from the lighting lamp from being transmitted to the outside.
